(19) United States
(12) Patent Application Publication
(10) Pub. No.: US 2009/0022900 A1
(43) Pub. Date: Jan. 22, 2009

(54) METHOD FOR MANUFACTURING WIRE GRID DEVICE

(75) Inventors: Su-mi Lee, Hwaseong-si (KR); Chan-hwa Chung, Seoul (KR); Moon-gyu Lee, Suwon-si (KR); Jung-woo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/045,039

(22) Filed: Mar. 10, 2008

(30) Foreign Application Priority Data
Jul. 19, 2007 (KR) 10-2007-0072486

(51) Int. Cl. B05D 1/32; B05D 5/00

(52) U.S. Cl. 427/466; 427/286

(57) ABSTRACT

A method of manufacturing a wire grid device is provided. The method includes: forming SAM (self assembly monomer) nano patterns on a substrate; and forming a wire grid between neighboring SAM nano patterns on the substrate on which the SAM nano patterns are formed by using an electroless plating technique or forming the wire grid on the SAM nano patterns on the SAM nano patterns by using the SAM nano patterns as a seed layer by using the electroless plating technique.

### CROSS-REFERENCE TO RELATED PATENT APPLICATION

This application claims the benefit of Korean Patent Application No. 10-2007-0072486, filed on Jul. 19, 2007, in the Korean Intellectual Property Office, the disclosure of which is incorporated herein in its entirety by reference.

### BACKGROUND OF THE INVENTION

1. Field of the Invention

The present invention relates to a method of manufacturing a wire grid device, and more particularly, to a method of manufacturing a wire grid device having high aspect ratio, which can be used as a wire grid polarizer.

2. Description of the Related Art

In the field of display devices, for displaying massive image information including natural moving pictures, the demands for high resolution, high efficiency, and low power consumption have recently increased. In addition, as the area of a display device increases, a technique for manufacturing elements of a large area display with high productivity has been also required.

Specifically, a liquid crystal display device (LCD) has considerably low light efficiency, since the LCD provides only 5 to 7% of light supplied from a light source such as a light emitting device (LED) or cold cathode fluorescent lamp (CCFL) to a user.

As is widely known, this is mainly because only unidirectionally polarized light of non-polarized incident light is used as effective light, since the LCD displays images by using changes in polarization characteristics. Accordingly, it is urgently necessary to improve the efficiency of light.

A conventional LCD includes two absorption type polarizing plates on and under a liquid crystal layer so as to perform an optical switching process. In this case, arithmetically, a loss of light is 50% of a non-polarized incident light beam. In order to reduce the loss of light, recently, the 3M Corporation has tried to improve luminance by using an optical sheet with high efficiency such as a dual brightness enhancement film (DBEF). However, the DBEF is not a perfect polarizer. In order to manufacture the DBEF, a process of laminating about six hundred thin films or more is required. Accordingly, it is difficult to reduce production costs.

Thus, a reflection type polarizer capable of recycling light by transmitting light that is polarized in a predetermined direction and reflecting light that is polarized in the direction orthogonal to the predetermined direction has been suggested. A typical example of the reflection type polarizer is a wire grid polarizer (WGP).

The WGP has a wire grid structure wherein an interval between neighboring wires is equal to or less than half of the minimum wavelength of light to be used. In a conventional process of manufacturing a WGP with a fine line width, nano grid patterns are manufactured by using an electron beam (e-beam) exposure method or laser interference exposure method, and a mould with respect to the nano grid patterns is manufactured by using polymers.

The mould is manufactured by using a nano-imprinting method such as a UV curing method or a hot embossing method. In order to manufacture the wire grid by using the aforementioned mould, an oblique deposition method including a lift-off process or a chemical vapor deposition (CVD) process used in a process of manufacturing a semiconductor is used.

In the case of the oblique deposition method, it is difficult to obtain a typical rectangular shape with high aspect ratio equal to or greater than 2:1 or 3:1, which is needed to obtain basic characteristics of the WGP. The oblique deposition method is not suitable for a process for a large display required for manufacturing a television. In addition, the asymmetry of a metal structure obtained by performing the oblique deposition, which is based on the direction of the oblique deposition, may influence the transmission/reflection characteristics of incident light based on the incident direction. This may cause angle dependence of a polarizing plate and a limit of the viewing angle of the display device. In the case of the lift-off process, since the resin that is used as an upper mask in a nano-imprinting process is weak in an etching process, it is difficult to form a wire grid with high aspect ratio. Also, the lift-off process is disadvantageous since it includes a higher number of operations than processes in depositing metal.

### SUMMARY OF THE INVENTION

The present invention provides a method of manufacturing a wire grid device with high aspect ratio via a cheap wet process by using an electroless plating process, which does not limit of manufactured area.

The present invention also provides a method of manufacturing a wire grid device, in which fine metal patterns are formed with an interval smaller than half the wavelength of light to be used by using an electroless plating process, as a wire grid polarizer.

According to an aspect of the present invention, there is provided a method of manufacturing a wire grid device, the method comprising: (A) forming SAM (self assembly monomer) nano patterns on a substrate; and (B) forming a wire grid between neighboring SAM nano patterns on the substrate on which the SAM nano patterns are formed using one of an electroless plating technique.

In the above aspect of the present invention, the aforementioned method may further comprise: (C) repeating a process of increasing the height of the SAM of the SAM nano patterns by growing the SAM and increasing the height of the wire grid by using the electroless plating technique.

In addition, in (A) the SAM nano patterns may be formed by using a micro-contact printing technique.

At this time, the thickness of the SAM nano patterns formed by using the micro-contact printing technique may range from 1 nm to 10 nm.

In addition, (A) may comprise: attaching the SAM to a stamp with nano patterns corresponding to the SAM nano patterns used for the micro-contact printing technique; and forming the SAM nano patterns by micro-contact printing the SAM attached to the stamp on the substrate.

In addition, the attaching of the SAM to the stamp may comprise: attaching the SAM to the stamp by dipping the stamp into a SAM solution; and drying the stamp.

In addition, the substrate may be capable of chemically absorbing a SAM material, and the SAM may contain a silane based compound.

At this time, the substrate may be made of silicon dioxide (SiO₂) or optically transparent plastic of which surface is processed by using a material for supplying oxygen.

In addition, the wire grid may further comprise an adhesion promotion layer for increasing bonding strength between the SAM material and the substrate, the SAM nano patterns are formed on the adhesion promotion layer, and the SAM nano patterns are made of an alkanethiol based material.

In addition, the SAM may contain a material of CH₃(CH₂)ₙSH: n=11˜25.

In addition, the wire grid may be formed by using the electroless plating technique by removing the adhesion promotion layer except a part of the adhesion layer on the SAM nano patterns.

In addition, the wire grid may be formed by using the electroless plating technique by maintaining the other part of the adhesion promotion layer that is not located under the SAM nano patterns, and the adhesion promotion layer may be made of a metal to which the electroless plating technique can be applied.

In addition, the substrate may be an optically transparent substrate.

In addition, in (B), the wire grid may be formed on the substrate by using the electroless plating technique using glucose.

Specifically, in (B), the wire grid may be formed on the substrate by using the electroless plating technique using a silver solution and a reduction solution including glucose and tartaric acid.

In addition, the wire grid may further comprise the seed layer at locations at which the wire grid is to be formed on the substrate, and in (B), the wire grid may be formed by using tartaric acid.

In addition, in (B), the wire grid may be formed on the seed layer by using the electroless plating technique using the silver solution and the reduction solution including tartaric acid.

In addition, the seed layer may contain tin chloride (SnCl₂).

According to an aspect of the present invention, there is provided a method of manufacturing a wire grid device, the method comprising: (A) forming SAM (self assembly monomer) nano patterns on a substrate; and (B) forming the wire grid on the SAM nano patterns on the SAM nano patterns by using the SAM nano patterns as a seed layer by using the electroless plating technique.

In addition, the aforementioned method may further comprise: (C) forming SAM regions by allowing the substrate between neighboring wires of the wire grid to absorb the SAM; and (D) repeating a process of increasing the height of the SAM of the SAM nano patterns by growing the SAM and increasing the height of the wire grid by using the electroless plating technique.

In addition, (C) may comprise: absorbing a precursor material on the substrate so as to electrically charge the substrate; and absorbing a first SAM material that is oppositely charged to the precursor on the precursor.

In addition, the aforementioned method may further comprise absorbing a second SAM material that is oppositely charged to the first SAM material, wherein in (D), the SAM is grown by alternately absorbing the first and second SAM materials.

In addition, the precursor may contain 3-aminopropyldimethylethoxysilane, the first SAM material may contain polyallylamine hydrochloride (PAH), and the second SAM material may contain polyvinylsulfate potassium salt (PVS).

Here, the SAM used for forming the SAM nano patterns may contain triethoxysilylundecanal.

In addition, the substrate may be made of silicon dioxide (SiO₂) or optically transparent plastic of which surface is processed by using a material for supplying oxygen.

In addition, the wire grid may be a wire grid polarizer.

At this time, (C) may be repeated until the height of the wire grid is equal to or greater than 100 nm.

In addition, an interval between neighboring wires of the wire grid may be less than half wavelength of mainly used light.

In addition, the wire grid may have aspect ratio equal to or greater than 2:1 or 3:1.

In addition, in the wire grid device, the SAM nano patterns may be located between wires.

In addition, the aforementioned method may further comprise removing the SAM nano patterns, after forming the wire grid.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are respectively a sectional view and a top plan view illustrating a schematic structure of a wire grid polarizer;

FIG. 2 illustrates an operating mechanism of a reflection type wire grid polarizer;

FIGS. 3A to 3F are flow diagrams of a method of manufacturing a wire grid device according to an embodiment of the present invention;

FIG. 4 illustrates a wire grid device in which the SAM nano patterns are located between neighboring wires of the wire grid without removing the SAM nano patterns after forming the wire grid with a desirable height by using a method of manufacturing the wire grid device according to an embodiment of the present invention.

FIGS. 5A and 5B illustrate structures corresponding to FIGS. 3C and 3D, respectively when a wire grid is formed by using the electroless plating process using tartaric acid by including a seed layer at locations at which the wire grid is formed on a substrate.

FIGS. 6A to 6F are flow diagrams of a method of manufacturing a wire grid device according to another embodiment of the present invention;

FIG. 7 illustrates a wire grid device in which the SAM nano patterns are located between neighboring wires of the wire grid without removing the SAM nano patterns after forming the wire grid with a desirable height by using a method of manufacturing the wire grid device according to another embodiment of the present invention;

FIGS. 8A to 8H are flow diagrams of a method of manufacturing a wire grid device according to still another embodiment of the present invention; and

FIG. 9 illustrates a wire grid device in which the SAM areas are located between neighboring wires of the wire grid without removing the SAM area after forming the wire grid with a desirable height by using a method of manufacturing the wire grid device according to still another embodiment of the present invention.

### DETAILED DESCRIPTION OF THE INVENTION

Hereinafter, a method of manufacturing a wire gird according to an exemplary embodiment of the present invention will be described in detail with reference to the attached drawings. It is possible to manufacture a wire grid polarizer with high aspect ratio by using a cheap wet process without a limit of a manufactured area by using a method of manufacturing a wire grid according to an embodiment of the present invention.

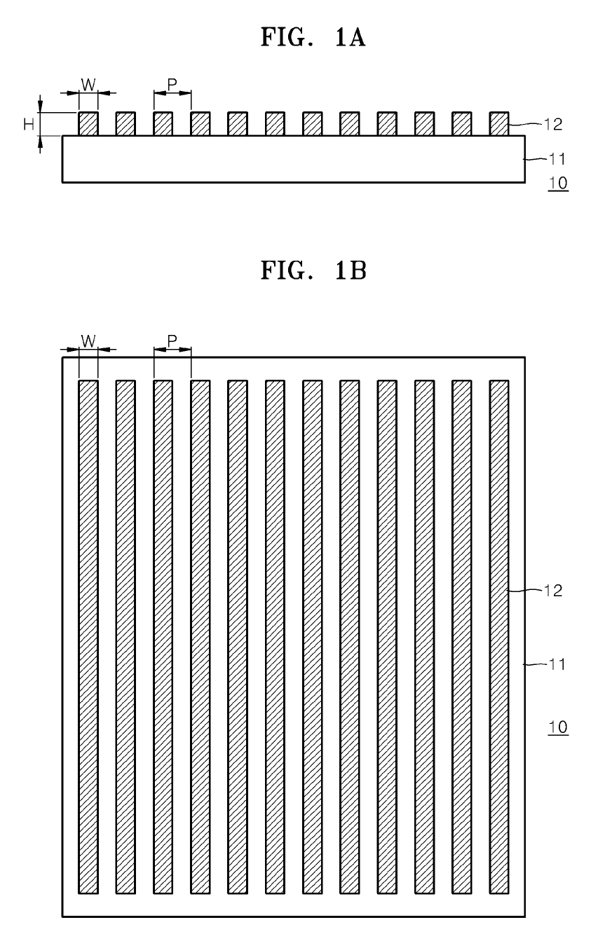

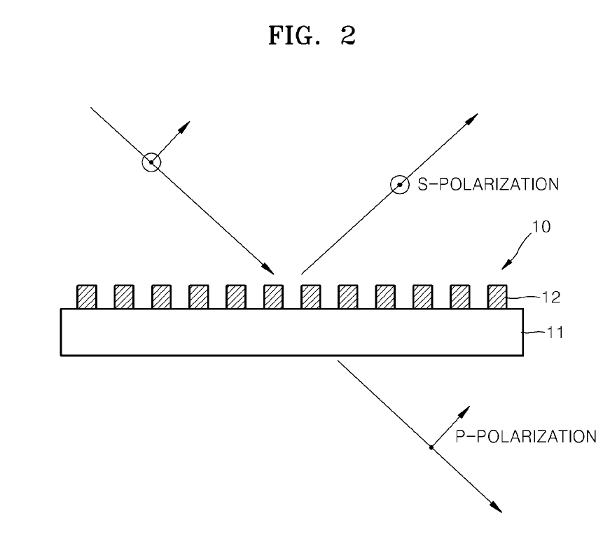

FIGS. 1A and 1B are a sectional view and a top plan view illustrating a schematic structure of a wire grid polarizer. FIG. 2 illustrates an operating mechanism of a reflection type wire grid polarizer.

As shown in FIGS. 1A and 1B, a wire grid polarizer 10 has a structure in which a plurality of conductive wires 12 are arranged in parallel with one another at a predetermined interval. If the interval between neighboring wires 12 becomes larger than the wavelength of incident light, the wire gird polarizer 10 e becomes more similar to a diffraction grating. On the contrary, if the interval between neighboring wires 12 becomes smaller than the wavelength of the incident light, the wire grid polarizer 10 becomes more similar to a polarizer.

The wire grid polarizer 10 includes fine patterns with an interval smaller than half of the wavelength of light so as to operate as a polarizer with high efficiency.

When the wire grid polarizer 10 has the characteristics of a polarizer, the wire grid polarizer 10 reflects light of which polarization component is parallel with the wires 12 and transmits light of which polarization component is orthogonal to the wires 12.

The wire grid polarizer 10 having characteristics of separating and polarizing light in a whole range of visible light has a minimum line width W of about 50 nm. The thickness of a layer for forming the wires 12, that is, the height H of the wires 12, is equal to or greater than 100 nm. For example, the height H ranges from 100 nm to 140 nm. In addition, the grid pattern period P of the wires 12 of the wire grid polarizer 10 is equal to or less than half-wavelength of light to be used. For example, the grid pattern period P has to be about 100 nm.

In order to manufacture the wire grid with high aspect ratio, the present invention uses a micro-contact printing process instead of a conventional nano-imprinting method using heat or pressure and thus a loss of a master mold caused by heat and pressure is relatively reduced. It is possible to solve problems in that patterns are elongated and in that separation is difficult, when separating a mold from a substrate by applying the nano-imprinting method to patterns with fine line width.

In the process of manufacturing the wire grid according to the present invention, at first, self-assembled monomer (SAM) nano patterns are formed on a transparent substrate through a micro-contact printing process using a SAM by using the master mold as a stamp.

Then, metal fills spaces between neighboring SAM nano patterns by using an electroless plating process. It is possible to easily perform the process of manufacturing the wire grid with high aspect ratio by repeating the aforementioned processes.

In general, in the electroless plating process, it is known that it is difficult to form a perfect shape of the wire grid by perfectly filling spaces with channel shapes between neighboring patterns with high aspect ratio with metal from the bottoms of the patterns.

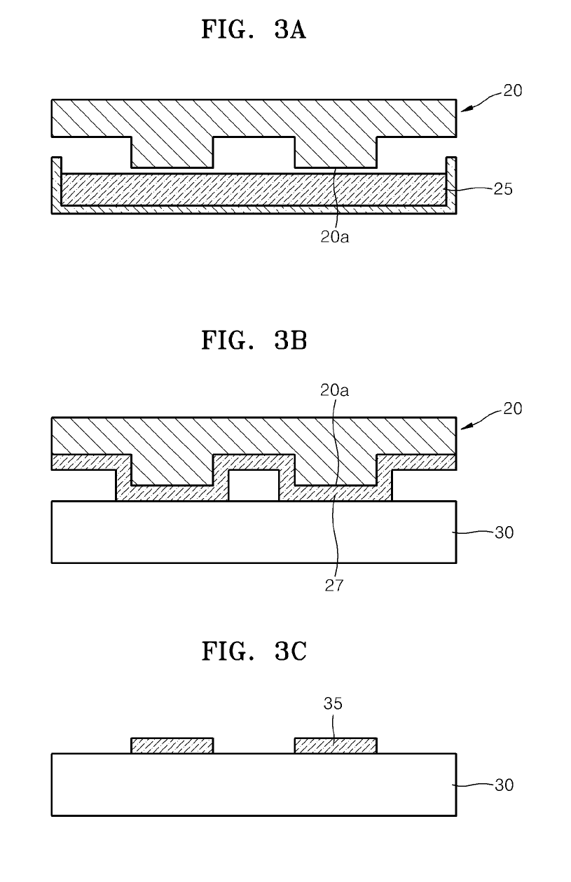

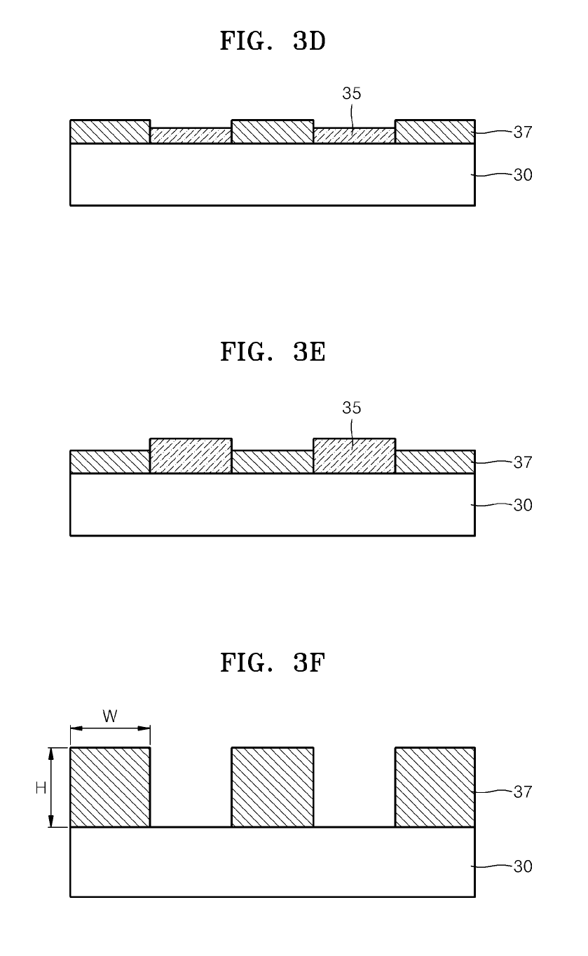

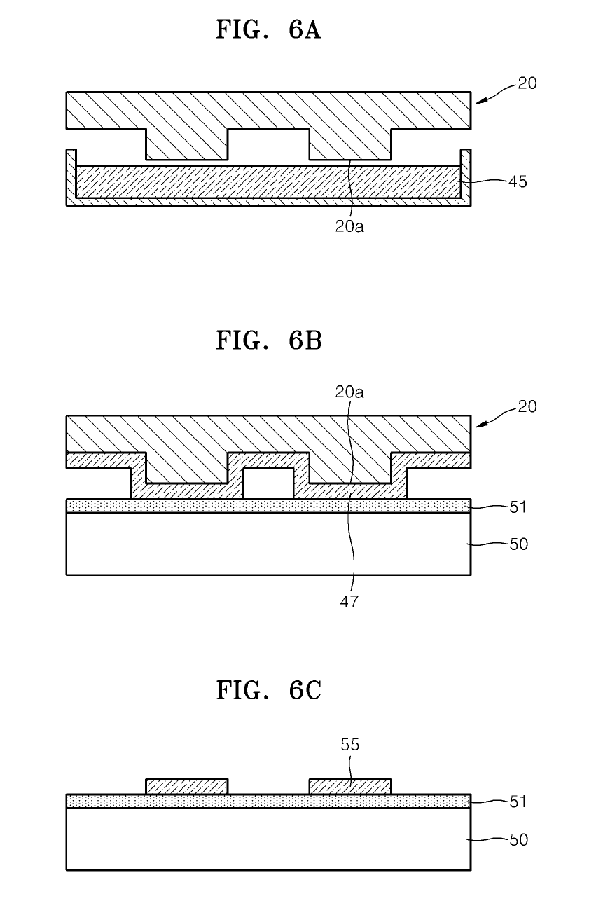

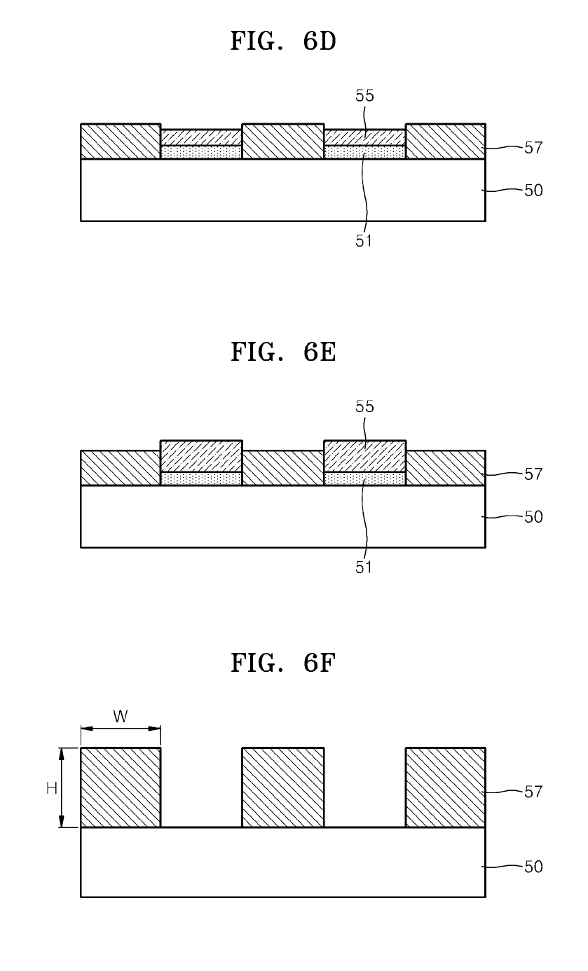

However, according to the embodiment of the present invention, as shown in FIGS. 3 and 6, the plating process is repeatedly performed while increasing the height of the SAM nano patterns by gradually growing the SAM. Accordingly, in a practical unit process, since low aspect ratio of the patterns is maintained, it is possible to reduce loads of the plating process.

Accordingly, in the method of manufacturing the wire grid according to the embodiment of the present invention, it is possible to easily manufacture the wire grid with high aspect ratio. It is possible to form a wide grid polarizer with high aspect ratio having a large area at low costs.

FIGS. 3A to 3F are flow diagrams of a method of manufacturing a wire grid device according to an embodiment of the present invention.

Referring to FIGS. 3A to 3C, SAM nano patterns 35 are formed on a substrate 30. The SAM nano patterns 35 may be formed by using a micro-contact printing technique.

In order to form the SAM nano patterns 35, as shown in FIGS. 3A and 3B, a SAM 25 is attached to a stamp 20 used for the micro-contact printing technique in which nano patterns 20a corresponding to the SAM nano patterns 35 are formed. Then, a thin SAM film 27 is formed on the stamp 20.

In order to form the thin SAM film 27 by attaching the SAM to the stamp 20, the SAM is attached to the stamp 20 by dipping the stamp 20 into the SAM solution 25. As shown in FIG. 3b, when the stamp 20 is dried, the SAM film 27 is obtained.

As shown in FIG. 3B, when the micro-contact printing process is performed on the substrate 30 by using the stamp 20 having the SAM film 27, as shown in FIG. 3C, the SAM nano patterns 35 corresponding to the nano patterns 20a of the stamp 20 are formed on the substrate 30.

That is, as shown in FIG. 3B, when the stamp 20 having the SAM film 27 is pressed on the substrate 30, the SAM film 27 attached on the nano patterns 20a of the stamp 20 is micro-contact printed on the substrate 30. Accordingly, as shown in FIG. 3C, the SAM nano patterns 35 corresponding to the nano patterns 20a of the stamp 20 are formed on the substrate 30.

The thickness of an initial SAM nano patterns 35 formed by this micro-contact printing process ranges from 1 nm to 10 nm, and more preferably, from 2 nm to 4 nm.

In the current embodiment, since the SAM nano patterns 35 are directly formed on the substrate 30 by using the micro-contact printing technique, the substrate may be made of a material capable of chemically absorbing a SAM material and the SAM nano patterns 35 may be made of a SAM material capable of chemically absorbing the substrate 30.

For example, the substrate 30 may be made of optically transparent glass with respect to incident light or optically transparent plastic of which surface is treated by using a material for supplying oxygen, for example, O₂-plasma.

In addition, in order to allow the substrate 30 to chemically absorb the SAM nano patterns 35, the SAM film 27 may contain a silane based compound.

The SAM film 27 may contain a material selected from the group consisting of dodecylchlorosilane (CH₃(CH₂)₁₁SiCl₃, hereinafter, referred to as DTS), 3-aminopropyltriethoxysilane (H₂N(CH₂)₃Si(OCH₂CH₃)₃, hereinafter, referred to as APTES), and triethoxysilylundecanal (CH₃CH₂O)₃Si(CH₂)₁₀COH, hereinafter, referred to as TESUD)

When the SAM 25 is made of DTS, for example, the stamp 20 used for the micro-contact printing process is dipped into a DTS SAM solution (5˜10*10⁻³ M DTS in toluene), for example, for about two hours. Then, when the stamp 20 is dried, for example, for about 5 to about 10 minutes, the SAM film 27 is obtained. When the SAM film 27 is micro-contact printed on the substrate 30, the SAM nano patterns 35 are obtained.

Next, as shown in FIG. 3d, a wire grid 37 is formed by filling spaces between neighboring SAM nano patterns 35 with metal by using the electroless plating process. The wire grid 37 may contain silver (Ag).

The wire grid 37 may be formed by using the electroless plating technique using glucose. For example, the wire grid 37 may be formed on the substrate 30 by using the electroless plating process using a silver solution and a reduction solution including glucose and tartaric acid.

The silver solution may be obtained as follows. An ammonia solution is input into a solution obtained by mixing silver nitrate (AgNO₃) of 3.5 g with deionized water (DI water) of 60 ml, until precipitated materials are dissolved again. Then, a solution obtained by sodium hydroxide (NaOH) of 2.5 g with the DI water of 60 ml is input into the obtained solution, and the ammonia solution is input again in the newly obtained solution until precipitated materials are dissolved again.

The reduction solution including glucose and tartaric acid may be obtained as described in the following. Solvents are completely dissolved by heating a solution obtained by mixing glucose of 4.5 g and tartaric acid of 0.4 g with the DI water of 100 ml is heated for about 10 minutes. Then, ethylalcohol of 10 ml is input into the aforementioned solution at a room temperature.

For example, when the substrate 30 on which the SAM nano patterns 35 are formed is dipped into a solution obtained by mixing the silver solution with the reduction solution in the ratio of about 1:1, in a temperature range between about 20° C. and about 25° C., in a pH range between about 9 and about 13, silver (Ag) is plated on the surface, on which the SAM nano patterns 35 are not located, of the substrate 30. Accordingly, the wire grid 37 is formed.

After forming the wire grid 37 by using the electroless plating process, as shown in FIG. 3E, the height of the SAM of the SAM nano patterns 35 is increased by growing the SAM. Then, the height H of the wire grid 37 is increased by filling spaces between neighboring SAM nano patterns 35 with metal by performing the electroless plating process again.

The process of growing the SAM and the process increasing the height of the wire grid by using the electroless plating process are alternately repeated until the height H of the wire grid 37 becomes equal to or greater than a predetermined height, for example, 100 nm.

The number of repetitions of these processes is determined based on the thickness of the SAM layer obtained by performing the process of growing the SAM once. In order to form a layer of the wire grid 37 of which thickness is equal to or greater than 100 nm, for example, these processes are typically repeated ten times or more.

At this time, since the plating process is repeatedly performed while increasing the height of the SAM nano patterns 35 by gradually growing the SAM, low aspect ratio of the patterns is maintained in a practical unit process. Accordingly, it is possible to reduce loads of the plating process.

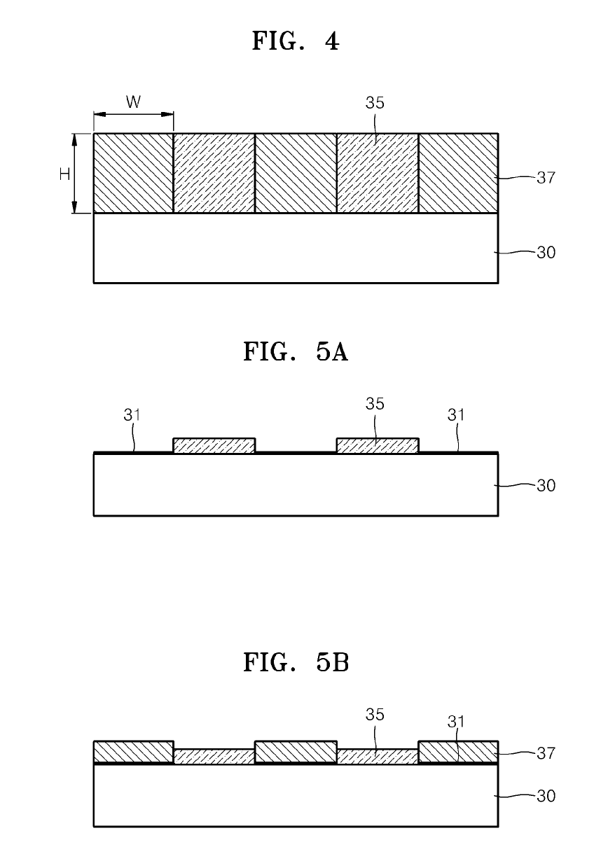

When the electroless plating process is performed while increasing the height of the SAM nano patterns 35 by gradually growing the SAM, as shown in FIGS. 3F and 4, the wire grid device in which the patterns of the wire grid 37 with high aspect ratio having a desirable height are formed, for example, a wire grid polarizer described with reference to FIGS. 1A to 2 may be manufactured.

After forming the wire grid 37 with the desirable height, the SAM nano patterns 35 may be removed or not, if necessary.

FIG. 3F illustrates a wire grid device obtained by performing a process of removing the SAM nano patterns 35 after forming the wire grid 37 with the desirable height.

FIG. 4 illustrates a wire grid device in which the SAM nano patterns 35 are located between neighboring wires of the wire grid 37 without removing the SAM nano patterns 35 after forming the wire grid 37 with a desirable height.

Accordingly, as shown in FIG. 3F, the wire grid polarizer manufactured by using the aforementioned method may have a structure having only the patterns of the wire grid 37 by removing the SAM nano patterns 35. As shown in FIG. 4, the wire grid polarizer may have a structure in which the SAM nano patterns 35 may be located between neighboring wires of the wire grid 37.

Up to now, in the method of manufacturing the wire grid device according to an embodiment of the present invention, the wire grid 37 is formed by using the electroless plating technique using glucose.

However, for example, the wire grid 37 may be formed by using tartaric acid. When the wire grid 37 is formed by using the electroless plating technique using tartaric acid, as shown in FIGS. 5A and 5B, a seed layer is needed.

FIGS. 5A and 5B correspond to FIGS. 3C and 3D, respectively. In order to form the wire grid 37 by using the electroless plating process using tartaric acid, a seed layer 31 is included at locations where the patterns of the wire grid 37 are formed on the substrate 30. The seed layer 31 may contain tin chloride (SnCl₂).

The seed layer 31 may be formed on the substrate 30 before or after forming the SAM nano patterns 35 by using the micro-contact printing process.

When the seed layer 31 containing tin chloride (SnCl₂) is formed on the substrate 30 before forming the SAM nano patterns 35, the surface density of tin chloride (SnCl₂) of the seed layer 31 is suitably controlled so that there is no problem in chemical absorption between the SAM of the SAM nano patterns 35 and the substrate 30. Accordingly, it is possible to perform micro-contact printing process for the SAM. At the same time, the seed layer 31 can serve as a seed layer of an Ag-electroless plating process.

When the seed layer 31 containing tin chloride (SnCl₂) is formed on the substrate 30 after forming the SAM nano patterns 35, tin chloride (SnCl₂) may be formed on the SAM nano patterns 35, in addition to at locations in which the patterns of the wire grid 37 are formed on the substrate 30. In this case, it is necessary to form the seed layer 31 containing tin chloride (SnCl₂) on the SAM nano patterns 35 to the minimum, so that the seed layer 31 may not influence the growth of the SAM on the SAM nano patterns 35.

In FIGS. 5A and 5B, the thickness of the seed layer 31 is substantially exaggerated for clarity. Although the seed layer 31 is located on or under the SAM nano patterns 35, since the seed layer 31 does not substantially influence the chemical absorption between the SAM nano patterns 35 and the substrate 30 or the growth of the SAM on the SAM nano patterns 35, drawing of the seed layer 31 is omitted.

When the seed layer 31 containing tin chloride (SnCl₂) is formed at locations at which the patterns of the wire grid 37 are to be formed on the substrate 30, the wire grid 37 may be formed by using the electroless plating technique using tartaric acid. For example, the wire grid 37 may be formed on the seed layer 31 by using the electroless plating using a silver solution and a reduction solution including tartaric acid.

At this time, the silver solution may be obtained by using 8.2 g of silver nitrate (AgNO₃), 6.5 g of ammonia solution, and 100 ml of DI water.

The reduction solution including tartaric acid may be obtained by using 29 g of tartaric acid, 2 g of magnesium sulfate (MgSO₄), and 100 ml of DI water.

For example, when the substrate 30 on which the seed layer 31 is formed is dipped into a solution obtained by mixing the silver solution with the reduction solution in the ratio of about 1:1, in a temperature range between about 20° C. and about 25° C., in a pH range between about 9 and about 13, silver (Ag) is plated on the seed layer 31, on which the SAM nano patterns 35 are not located, of the substrate 30. Accordingly, the wire grid 37 is formed.

As described above, after forming the wire grid 37 by using the electroless plating process, the height of the SAM of the SAM nano patterns 35 is increased. Then, the height H of the wire grid 37 is increased by filling spaces between neighboring SAM nano patterns 35 with metal by performing the electroless plating process, again.

The process of growing the SAM and the process increasing the height H of the wire grid 37 by using the electroless plating process are alternately repeated, until the height H of the wire grid 37 becomes equal to or greater than a predetermined height, for example, 100 nm.

As described above, when the wire grid 37 is formed by using the electroless plating technique using the tartaric acid, the seed layer 31 is further needed. Since the remaining processes in this case are substantially the same as those described with reference to FIGS. 3A to 4 except the solution used for the electroless plating process, description on the remaining processes will be omitted.

Up to now, the process of manufacturing the wire grid device, for example, the wire grid polarizer, in which the material of the SAM and the material of the substrate are selected so that the substrate can chemically absorb initial SAM nano patterns formed on the substrate by using the micro-contact printing process, is exemplified.

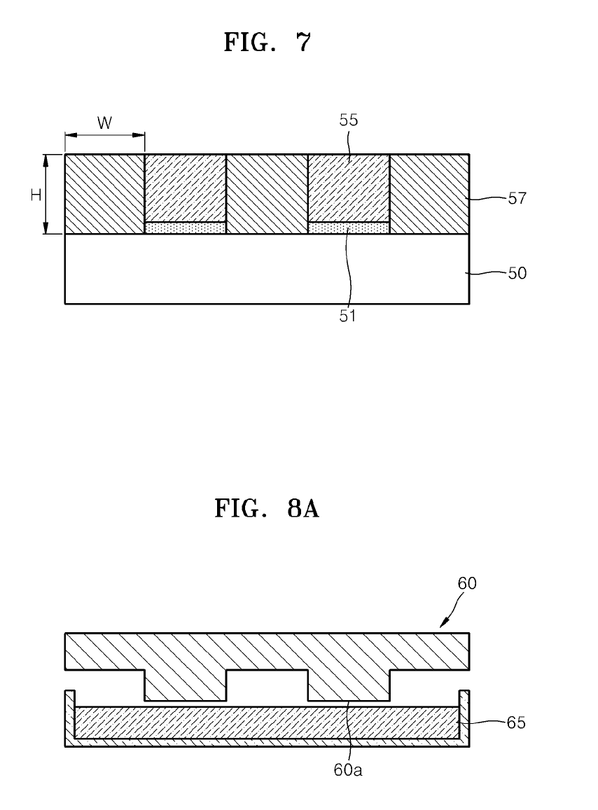

When the initial SAM nano patterns formed on the substrate by using the micro-contact printing process are made of a SAM material, for example, a alkanethiol-based SAM material that is not chemically absorbed by the substrate in a suitable manner, a glass substrate or transparent plastic substrate of which surface is treated by using a material containing oxygen has weak bonding strength with the SAM nano pattern. Accordingly, as shown in the following embodiment described with reference to FIGS. 6A to 7, a substrate further including an adhesion promotion layer for increasing the bonding strength with the SAM material is needed.

FIGS. 6A to 6F are flow diagrams of a method of manufacturing a wire grid device according to another embodiment of the present invention. In the following description, the part that is the same as the method according to the embodiment of the present invention described with reference to FIGS. 3A to 4 will be briefly described or omitted.

Referring to FIGS. 6A to 6C, a SAM film 47 is formed by attaching a SAM 45 to the stamp 20 used for the micro-contact printing process in which the nano patterns 20a corresponding to SAM nano patterns 55 are formed. Then, the SAM nano patterns 55 are formed on the adhesion promotion layer 51 by micro-contact printing the SAM 45 on a substrate 50 on which the adhesion promotion layer 51 is formed.

At this time, the thickness of an initial SAM nano patterns 55 formed by the micro-contact printing process may range from about 1 nm to about 10 nm, and more preferably, from about 2 nm to about 4 nm.

In the current embodiment, the SAM material forming the SAM nano patterns 55 may contain material containing thiol-based molecules, for example, an alkanethiol (CH₃(CH₂)ₙSH: n=11˜25) based. For example, the SAM material forming the SAM nano patterns 55 may contain at least one material selected from the group consisting of 1-dodecanethiol (CH₃(CH₂)₁₁SH), 1-hexadecanethiol (CH₃(CH₂)₁₅SH), and 1-octadecanethiol (CH₃(CH₂)₁₇SH).

The adhesion promotion layer 51 is formed on the substrate 50 so as to increase the bonding strength between the SAM material and the substrate 50. The adhesion promotion layer 51 may be made of a material containing gold (Au) having a thickness that ranges from about 2 nm to about 4 nm.

An Au-layer increases the bonding strength between the SAM containing the thiol based molecules and the substrate. Accordingly, when the adhesion promotion layer 51 contains gold (Au), the SAM for forming the SAM nano patterns 55 may be made of a material such as an alkanethiol (CH₃(CH₂)ₙSH: n=11˜25) based material.

In addition, the adhesion promotion layer 51 may be made of a material containing at least one metal selected from the group consisting of copper (Cu), platinum (Pt), silver (Ag), nickel (Ni), palladium (Pd), and cobalt (Co), which increases the bonding strength between the SAM containing the thiol-based molecules and the substrate and allows the electroless plating process.

In addition, the adhesion promotion layer 51 may be made of a material containing at least one metal selected from the group consisting of alloys which contain at least one metal selected from the group consisting of copper (Cu), platinum (Pt), silver (Ag), nickel (Ni), palladium (Pd), and cobalt (Co), for example, cobalt-nickel alloy (CoNi), iron-platinum alloy (FePt), nickel-tungsten alloy (NiW), and the like.

On the other hand, in the current embodiment, since the substrate 50 is not chemically absorbed with the SAM nano patterns 55 in a direct manner, the substrate 50 may be made of a merely optically-transparent material. Of course, as in the aforementioned embodiment, the substrate 50 may be made of silicon dioxide (SiO₂) or optically transparent plastic of which surface is processed by using a material for supplying oxygen, for example, O₂-plasma.

The SAM nano patterns 55 may be formed as follows. For example, the substrate 50 on which the adhesion promotion layer 51 containing gold (Au) is formed is used. The stamp 20 used for the micro-contact printing process is dipped into the SAM solution containing 1-dodecanethiol and 1-hexadecanethiol (for example, a solution obtained by mixing 1-dodecanethiol of 1 mM and 1-hexadecanethiol with ethanol of 1 mM), for example, for about two hours. Then, when the stamp 20 is dried, for example, for about 5 to about 10 minutes, the SAM film 47 is obtained. When the SAM film 47 is micro-contact printed on the adhesion promotion layer 51 containing gold (Au), the SAM nano patterns 55 are obtained.

As described above, as shown in FIG. 6d, a wire grid 57 is formed by filling spaces between neighboring SAM nano patterns 55 with metal by using the electroless plating process. The wire grid 57 may contain silver (Ag).

Similarly to the aforementioned embodiment, the wire grid 57 may be formed on the adhesion promotion layer 51 or substrate 50 by using the electroless plating technique using glucose, for example, the electroless plating process using a silver solution and a reduction solution including glucose and tartaric acid.

As described in the aforementioned embodiment, the wire grid 57 may be formed on the adhesion promotion layer 51 or substrate 50 by using the electroless plating technique using tartaric acid, for example, the electroless plating process using a silver solution and a reduction solution including tartaric acid. At this time, the seed layer containing tin chloride (SnCl₂) may be formed at locations where the patterns of the wire grid 57 are to be formed on the adhesion promotion layer 51 or substrate 50 before or after forming the SAM nano patterns 55 by using the micro-contact printing technique. Then, the electroless plating process using the tartaric acid may be performed.

Here, the patterns of the wire grid 57 are formed by using the electroless plating technique by removing or maintaining the adhesion promotion layer 51, for example, a gold (Au) layer on the substrate 50 which is not located under the SAM nano patterns 55.

That is, the patterns of the wire grid 57 may be formed on the exposed substrate 50 by using the electroless plating technique by removing a part of the adhesion promotion layer 51 in a region non-existing the SAM nano patterns 55.

In addition, when the adhesion promotion layer 51 is made of metal to which the electroless plating technique can be applied, the patterns of the wire grid 57 are formed by using the electroless plating technique by maintaining a part of the adhesion promotion layer 51 in a region non-existing the SAM nano patterns 55.

After forming the wire grid 57 by using the electroless plating process, as shown in FIG. 6E, the height of the SAM of the SAM nano patterns 55 is increased by growing the SAM. Then, the height H of the wire grid 57 is increased by filling spaces between neighboring SAM nano patterns 55 with metal by performing the electroless plating process, again.

The process of growing the SAM and the process increasing the height of the wire grid by using the electroless plating process are alternately repeated until the height H of the wire grid 57 becomes equal to or greater than a predetermined height, for example, 100 nm.

Similarly to the aforementioned embodiment, the number of repetitions of these processes is determined based on the thickness of the SAM layer obtained by performing the process of growing the SAM once. In order to form a layer of the wire grid 37 of which thickness is equal to or greater than 100 nm, for example, these processes may be repeated ten times or more.

When the electroless plating process is performed while increasing the height of the SAM nano patterns 55 by gradually growing the SAM, as shown in FIGS. 6F and 7, the wire grid device in which the patterns of the wire grid 57 with high aspect ratio having a desirable height are formed, for example, a wire grid polarizer described with reference to FIGS. 1A to 2 may be manufactured.

After forming the wire grid 57 with the desirable height, the SAM nano patterns 55 may be removed or not, if necessary.

FIG. 6F illustrates a wire grid device obtained by performing a process of removing the SAM nano patterns 35 after forming the wire grid 37 with the desirable height.

FIG. 7 illustrates a wire grid device in which the SAM nano patterns 35 are located between neighboring wires of the wire grid 37 without removing the SAM nano patterns 35 after forming the wire grid 37 with a desirable height.

Accordingly, as shown in FIG. 6F, the wire grid polarizer manufactured by the aforementioned method may have a structure having only the patterns of the wire grid 57 by removing the SAM nano patterns 55. As shown in FIG. 7, the wire grid polarizer manufactured by the aforementioned method may have a structure in which the SAM nano patterns 55 may be located between neighboring wires of the wire grid 57.

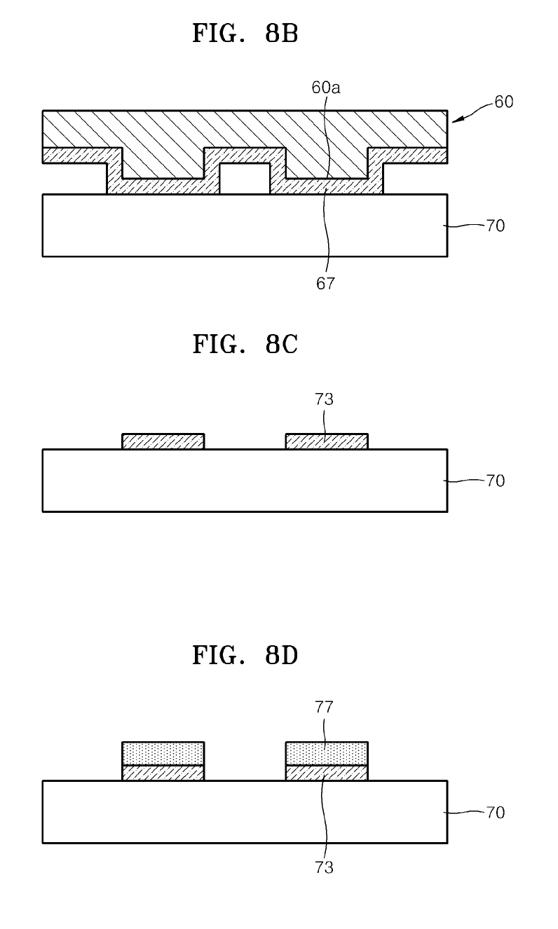

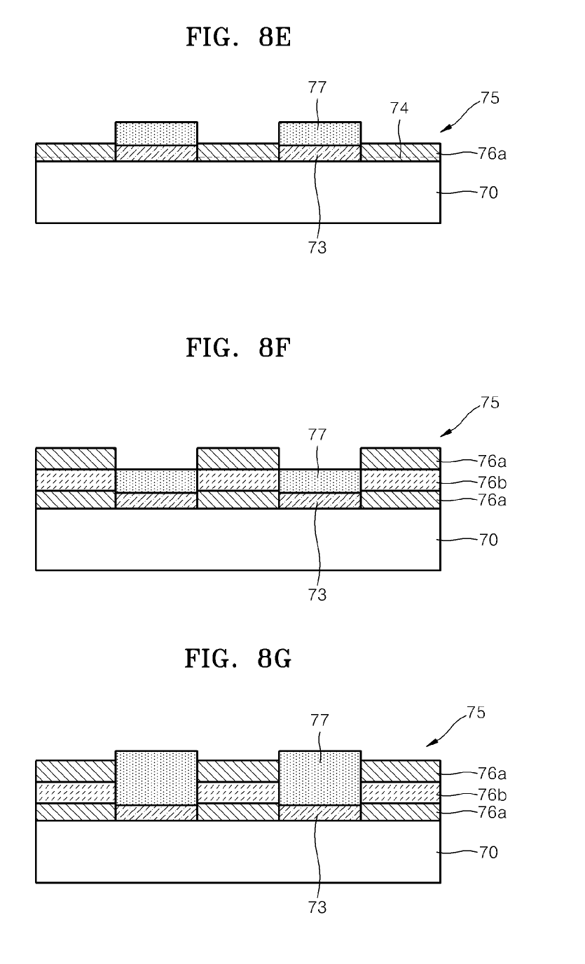

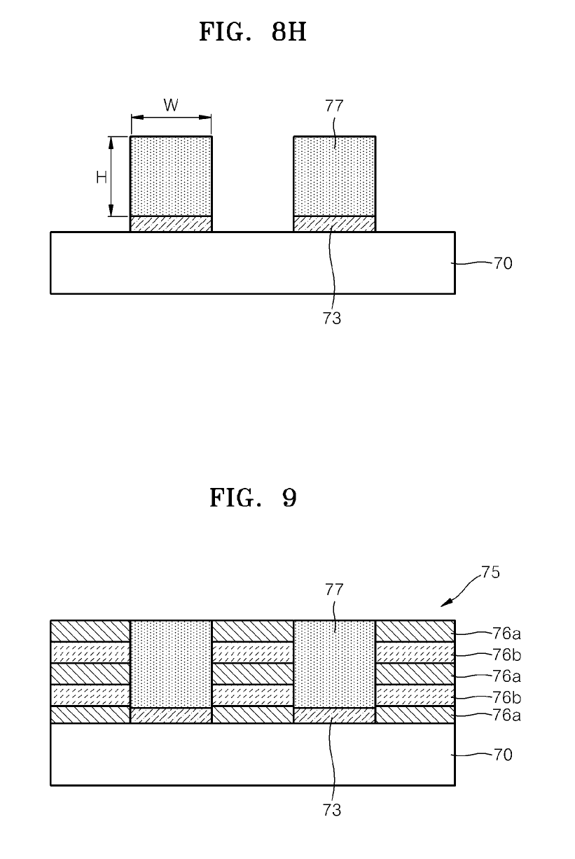

Up to now, the method of manufacturing the wire grid device in a case where the SAM nano patterns formed by using the micro-contact printing process substantially serves as a mask in the process of manufacturing the wire grid by using the electroless plating technique that is a cheap wet process has been described and shown. As described in the following embodiment with reference to FIGS. 8A to 9, it is possible to manufacture the wire grid device by using the SAM nano patterns formed by using the micro-contact printing process as a seed layer used to form the wire grid by using the electroless plating. In this case, the SAM areas made of an electrostatic SAM growth material may be formed in the spaces between neighboring wires of the wire grid.

FIGS. 8A to 8F are flow diagrams of a method of manufacturing a wire grid device according to still another embodiment of the present invention. In the following description, the part that is the same as the method according to the embodiments of the present invention described with reference to FIGS. 3A to 4 and 6A to 7 will be briefly described or omitted.

Referring to FIGS. 8A to 8D, SAM nano patterns 73 corresponding to desired wire grid 77 are formed on the substrate 70.

In order to form the SAM nano patterns 73, as shown in FIGS. 8A and 8B, a SAM film 67 is formed by attaching a SAM 65 to a stamp 60 used for the micro-contact printing process in which the nano patterns 60a corresponding to the SAM nano patterns 73 are formed.

Then, as shown in FIG. 8C, the SAM nano patterns 73 corresponding to the wire grid 77 are formed by micro-contact printing the SAM on the substrate 70. At this time, the thickness of the SAM nano patterns 73 formed by using the micro-contact printing process is sufficient to allow the SAM nano patterns 73 to serve as a seed layer for the electroless plating process. For example, the thickness of the SAM nano patterns 73 may range from about 0.5 nm to about 10 nm. For example, the SAM nano patterns 73 may have a thickness of about 1.2 nm.

As shown in FIG. 8D, the wire grid 77 is formed on the SAM nano patterns 73 through the electroless plating process by using the SAM nano patterns 73 as a seed layer.

In the current embodiment, in order to allow the substrate 70 to chemically absorb the SAM nano patterns 73, the SAM 65 may contain a silane based compound, for example, TESUD.

At this time, it is needed that the substrate 70 can chemically absorb the SAM nano patterns 73 and the substrate 70 may be an optically transparent. For example, when the SAM nano patterns 73 contain a SAM material that is a silane based compound, the substrate 70 may be made of optically transparent glass (SiO₂) in view of the incident light or optically transparent plastic of which surface is treated by using a material for supplying oxygen, for example, O₂-plasma.

Here, in order to form a thin SAM film 67 by attaching the SAM 65 to the stamp 60, the SAM is attached to the stamp 60 by dipping the stamp 60 into the SAM solution. And then, as shown in FIG. 8b, when the stamp 60 is dried, the SAM film 67 is obtained. When the micro-contact printing process is performed on the substrate 70 by using the stamp 60 having the SAM film 67, as shown in FIG. 8C, the SAM nano patterns 73 corresponding to the nano patterns 60a of the stamp 60 are formed on the substrate 70.

That is, as shown in FIG. 8B, when the stamp 60 having the SAM film 67 is pressed on the substrate 70, the SAM film 67 attached on the nano patterns 60a of the stamp 60 is micro-contact-printed on the substrate 70. Accordingly, as shown in FIG. 8C, the SAM nano patterns 73 corresponding to the nano patterns 60a of the stamp 60 are formed on the substrate 70.

The wire grid 77 is formed on the SAM nano patterns by using the electroless plating process by using the SAM nano patterns 73 as a seed layer.

The wire grid 37 may contain silver (Ag). Similarly to the aforementioned embodiments, the wire grid 77 may be formed on the SAM nano patterns 73 by using the electroless plating technique using glucose, for example, the electroless plating process using a silver solution and a reduction solution including glucose and tartaric acid.

After forming the wire grid 77 on the SAM nano patterns 73, as shown in FIGS. 8E and 8F, SAM areas 75 are formed by allowing the SAM to be absorbed by the substrate 70 between neighboring wires of the wire grid 77. At this time, the SAM areas 75 are formed by the electrostatic SAM growth technique.

In order to form the SAM areas 75, as shown in FIG. 8E, a precursor 74 is absorbed by the substrate 70 so as to electrically charge the substrate 70. A first SAM material 76a that is oppositely charged to the precursor 74 is absorbed on the precursor 74. Then, as shown in FIG. 8F, a second SAM material is absorbed on the first SAM material 76a.

The SAM is grown by alternately absorbing the first and second SAM materials 76a and 76b.

Here, in order to negatively charge the substrate 70, the precursor 74 may contain 3-aminopropyldimethylethoxysilane, the first SAM material 76a may contain positively charged polyallylamine hydrochloride (PAH), and the second SAM material 76b may contain negatively charged polyvinylsulfate potassium salt (PVS). In addition, the material of the precursor 74 and the first and second SAM materials 76a and 76b may be various SAM materials that can be used for the electrostatic SAM growth.

After growing the SAM area 75 until the SAM region 75 is higher than the wire grid 77, as shown in FIG. 8G, the height H of the wire grid 77 is increased by filling spaces between neighboring SAM regions 75 with metal by performing the electroless plating process, again.

The process of growing the SAM and the process increasing the height H of the wire grid 77 by using the electroless plating process are alternately repeated, until the height H of the wire grid 77 becomes equal to or greater than a predetermined height, for example, 100 nm.

Similarly to the aforementioned embodiments, the number of repetitions of these processes is determined based on the thickness of the SAM layer obtained by growing the SAM so that the SAM area is higher than the wire grid 77. In order to form a layer of the wire grid 77 of which thickness is equal to or greater than 100 nm, for example, these processes may be repeated ten times or more.

When the process of increasing the height of the SAM region 75 by growing the SAM and the process of increasing the height of the wire grid 75 by using the electroless plating process are repeated, as shown in FIGS. 8H and 9, the wire grid device in which the patterns of the wire grid 77 with high aspect ratio having a desirable height are formed, for example, a wire grid polarizer described with reference to FIGS. 1A to 2, is manufactured.

After forming the wire grid 77 with the desirable height, the SAM nano patterns 75 may be removed or not, if necessary.

FIG. 8H illustrates a wire grid device obtained by performing a process of removing the SAM area 75 after forming the wire grid 77 with the desirable height.

FIG. 9 illustrates a wire grid device in which the SAM area 75 are located between neighboring wires of the wire grid 77 without removing the SAM area 75 after forming the wire grid 77 with a desirable height.

Accordingly, as shown in FIG. 8H, the wire grid polarizer manufactured by the aforementioned method may have a structure having only the patterns of the wire grid 77 by removing the SAM areas 75. As shown in FIG. 9, the wire grid polarizer manufactured by the aforementioned method may have a structure in which the SAM areas 75 may be located between neighboring wires of the wire grid 77.

As described above, it is possible to manufacture the wire grid polarizer by using the method of manufacturing the wire grid polarizer according to an embodiment of the present invention, so that the interval P between neighboring wires of the wire grid may be less than half the wavelength of light to be used. In addition, it is possible to form the wire grid so as to have high aspect ratio greater than 2:1 or 3:1. In addition, it is possible to form the wire grid so that the minimum line width of finally formed wires may be about 50 nm and so that the thickness of the finally formed wire may be equal to or greater than 100 nm.

For example, it is possible to form the wire grid so that the width W of the wire of the wire grid ranges from 50 nm to 70 nm and so that the height H of the wire ranges 100 nm to 140 nm to have high aspect ratio of about 2:1.

Since the thickness of a plated layer formed in a unit process is controlled by controlling a plating period, a temperature, a pH value, concentrations of metal ions, a reducing agent, and an additive in an electrolyte, it is possible to control the number of repetitions of processes needed for forming the wire grid with a desirable thickness.

As described above, by using the method of manufacturing a wire grid device according to an embodiment of the present invention, it is possible to manufacture the wire grid device with high aspect ratio by using a cheap wet process.

In addition, it is possible to manufacture a wire grid polarizer with high aspect ratio by using a cheap wet process without a limit of a manufactured area by using the method of manufacturing the wire grid according to an embodiment of the present invention.

What is claimed is:

1. A method of manufacturing a wire grid device, the method comprising:
(A) forming SAM (self assembly monomer) nano patterns on a substrate; and
(B) forming a wire grid between neighboring SAM nano patterns on the substrate on which the SAM nano patterns are formed by using an electroless plating technique.

2. The method of claim 1, further comprising (C) repeating a process of increasing the height of the SAM of the SAM nano patterns by growing the SAM and increasing the height of the wire grid by using the electroless plating technique.

3. The method of claim 2,
wherein in (A) the SAM nano patterns are formed by using a micro-contact printing technique, and
wherein the thickness of the SAM nano patterns formed by using the micro-contact printing technique ranges from 1 nm to 10 nm.

4. The method of claim 2,
wherein in (A), the SAM nano patterns are formed by using a micro-contact printing technique,
wherein (A) comprises:
attaching the SAM to a stamp with nano patterns corresponding to the SAM nano patterns used for the micro-contact printing technique; and
forming the SAM nano patterns by micro-contact printing the SAM attached to the stamp on the substrate, and
wherein the attaching of the SAM to the stamp comprises:
attaching the SAM to the stamp by dipping the stamp into a SAM solution; and
drying the stamp.

5. The method of claim 2,
wherein the substrate which can chemically absorbing a SAM material is made of silicon dioxide (SiO₂) or optically transparent plastic of which surface is treated by using a material for supplying oxygen, and
wherein the SAM contains a silane based compound.

6. The method of claim 2,
wherein the wire grid further comprises an adhesion promotion layer for increasing bonding strength between the SAM material and the substrate,
wherein the SAM nano patterns are formed on the adhesion promotion layer, and
wherein the SAM nano patterns are made of an alkanethiol based material.

7. The method of claim 6, wherein the SAM contains a material of CH₃(CH₂)ₙSH: n=11˜25.

8. The method of claim 6, wherein the wire grid is formed by using the electroless plating technique by removing a part of the adhesion promotion layer in a region non-existing the SAM nano patterns.

9. The method of claim 6,
wherein the wire grid is formed by using the electroless plating technique by remaining a part of the adhesion promotion layer in a region non-existing the SAM nano patterns, and
wherein the adhesion promotion layer is made of a metal to which the electroless plating technique can be applied.

10. The method of claim 9, wherein the adhesion promotion layer is made of a metal containing at least one selected from the group consisting of copper (Cu), platinum (Pt), gold (Au), silver (Ag), nickel (Ni), palladium (Pd), cobalt (Co), and alloys containing at least one selected from the group consisting of copper (Cu), platinum (Pt), gold (Au), silver (Ag), nickel (Ni), palladium (Pd), and cobalt (Co).

11. The method of claim 2, wherein in (B), the wire grid is formed on the substrate by using the electroless plating technique using a silver solution and a reduction solution including glucose and tartaric acid.

12. The method of claim 2,
further comprises the seed layer at locations where the wire grid is to be formed on the substrate, and
wherein in (B), the wire grid is formed on the seed layer by using the electroless plating technique using the silver solution and the reduction solution including tartaric acid.

13. The method of claim 12, wherein the seed layer contains tin chloride (SnCl₂).

14. A method of manufacturing a wire grid device, the method comprising:
(A) forming SAM (self assembly monomer) nano patterns on a substrate; and
(B) forming the wire grid on the SAM nano patterns by using the electroless plating technique by using the SAM nano patterns as a seed layer.

15. The method of claim 14, further comprising:
(C) forming SAM regions by allowing the substrate between neighboring wires of the wire grid to absorb the SAM; and
(D) repeating a process of increasing the height of the SAM of the SAM regions by growing the SAM and increasing the height of the wire grid by using the electroless plating technique.

16. The method of claim 15, wherein (C) comprises:
absorbing a precursor material on the substrate so as to electrically charge the substrate; and
absorbing a first SAM material that is oppositely charged to the precursor on the precursor.

17. The method of claim 16, further comprising absorbing a second SAM material that is oppositely charged to the first SAM material,
wherein in (D), the SAM is grown by alternately absorbing the first and second SAM materials.

18. The method of claim 17,
wherein the precursor contains 3-aminopropyldimethylethoxysilane,
wherein the first SAM material contains polyallylamine hydrochloride (PAH), and
wherein the second SAM material contains polyvinylsulfate potassium salt (PVS).

19. The method of claim 15,
wherein in (A), the SAM nano patterns are formed by using the micro-contact printing technique, and
wherein (A) comprises:
attaching the SAM to a stamp with nano patterns corresponding to the SAM nano patterns used for the micro-contact printing technique; and
forming the SAM nano patterns by micro-contact printing the SAM attached to the stamp on the substrate.

20. The method of claim 19, wherein the attaching of the SAM to the stamp comprises:
attaching the SAM to the stamp by dipping the stamp into a SAM solution; and
drying the stamp.

21. The method of claim 15,
wherein the substrate which can chemically absorb a SAM material, and
wherein the SAM used for forming the SAM nano patterns contains triethoxysilylundecanal that is a silane based compound.

22. The method of claim 15, wherein in (B), the wire grid is formed on the SAM nano patterns by using the electroless plating technique using a silver solution and a reduction solution including glucose and tartaric acid.

23. The method of claim 14, wherein the substrate is made of silicon oxide (SiO₂) or optically transparent plastic of which surface is treated by using a material for supplying oxygen.

24. The method of claim 15, wherein the wire grid is a wire grid polarizer.

25. The method of claim 24,
wherein (C) is repeated until the height of the wire grid is equal to or greater than 100 nm, and
wherein an interval between neighboring wires of the wire grid is less than half the wavelength of used light.

26. The method of claim 24, wherein the wire grid has aspect ratio equal to or greater than 2:1 or 3:1.

27. The method of claim 1, wherein the substrate is made of silicon oxide (SiO₂) or optically transparent plastic of which surface is treated by using a material for supplying oxygen.

28. The method of claim 2, wherein the wire grid is a wire grid polarizer.

29. The method of claim 28,
wherein (C) is repeated until the height of the wire grid is equal to or greater than 100 nm, and
wherein an interval between neighboring wires of the wire grid is less than half the wavelength of used light.

30. The method of claim 28, wherein the wire grid has aspect ratio equal to or greater than 2:1 or 3:1.
